(19) United States
(12) Patent Application Publication
(10) Pub. No.: US 2026/0262576 A1
(43) Pub. Date: Sep. 10, 2026

(54) PLANT CONTAINERS

(71) Applicant: BudTrainer Inc., Waterloo (CA)

(72) Inventor: Henrique de Carvalho Dias, Waterloo (CA)

(73) Assignee: BudTrainer Inc., Waterloo, ON (CA)

(21) Appl. No.: 18/875,653

(22) PCT Filed: Oct. 18, 2024
(86) PCT No.: PCT/CA2024/051383

§ 371 Date: Dec. 16, 2024

Related U.S. Application Data
(60) Provisional application No. 63/592,738, filed on Oct. 24, 2023.

(51) Int. Cl. A01G 9/02; A01G 9/029; A01G 13/22

(52) U.S. Cl. CPC A01G 9/0302; A01G 9/0293; A01G 13/22

(57) ABSTRACT

Provided is a plant container including a bottomless cup, a bottom plate, and a dome. The bottomless cup holds growth media. The bottomless cup has side openings at the bottom edge for better drainage and to prevent waterlogging. The bottom plate with conical or convex shape and a drainage angle round drainage cutouts sits atop the base ridge on the bottomless cup. The bottom plate serves to hold the media and roots in place. The bottom plate provides drainage for the excess water. The bottom plate allows gardeners to more easily push their plants out of the container when they are ready to be removed or transplanted. The bottom plate also allows gardeners to more easily clean the container. The perforated transparent humidity dome has the same overall shape and size of the bottomless plastic cup.

### TECHNICAL FIELD

The embodiments disclosed herein relate to plant containers, and, in particular to improved plant containers for transplanting young plants while providing optimal drainage for the roots.

### INTRODUCTION

Transplanting, drainage, humidity control, and hygiene are areas of gardening that highly influence the outcomes of a crop. Transplanting helps plants develop more roots before being transferred into a larger container. Drainage helps with root development and prevents root rot. The right humidity is a catalyst for increasing photosynthesis. Clean equipment is an important starting point for a healthy crop.

Transplanting is a gardening technique where a gardener plants their seeds or clones into small containers, and once these young plants'roots outgrow their containers they are “transplanted” into larger containers to mature into adult plants. The larger containers will either be the final place where the plant will live, or the intermediary containers for a subsequent transplant. The advantages of transplanting include: (1) it saves initial gardening space since plants can be planted in smaller containers, taking up a smaller cultivation space; (2) this smaller space can be set to the ideal temperature and humidity conditions for each stage of growth; and (3) when plants develop their roots in a smaller container first, they grow stronger and larger roots when transplanted into a larger container later. Conversely, plants grown directly in the final container tend to develop roots toward the bottom half of the container but not around the top half, thus promoting less overall growth of the plant.

Problems with transplanting are twofold. First, it is difficult for beginners and requires advanced gardening skills. Common accidents, such as ripping the roots off or letting the soil come loose, can cause compromising damage to the plant being transplanted. Secondly, the act of transplanting stresses plants to varying degrees, stunting them for a few hours or sometimes a few days, where growth is limited. This disruption to the roots is called transplant shock.

Drainage is another important feature in gardening as it prevents waterlogging in the root zone. While roots consume water from the soil, they also need oxygen in order to grow. This oxygen can be found in small air gaps between soil particles, where the roots end up growing “into”. However, if these small oxygen gaps are covered by water the roots won't be able to develop, but instead they will suffocate and die, thus increasing the risk of fungal infections that spread to the healthier parts of the plant. Proper drainage is important for growing plants and excess water in the media (soil, peat, coco-coir, rockwool, etc.) is typically drained via the holes in the bottom of gardening containers or by the fabric in fabric grow bags. When devoid of these means gardeners use conventional containers to grow their plants in, such as plastic cups, and manually cut holes in the bottom edges for drainage-an activity that is inconsistent and time consuming.

While growers can purchase containers with holes in the bottom, or make those holes themselves, providing proper drainage for plants has another challenge that proves more problematic: runoff water that exits through the drain holes pools around the container and ends up water-logging the bottom roots, increasing the chances of root rot. To avoid this contact between the runoff and the bottom of the container, gardeners often raise their pots from the ground with raised platforms, usually referred to as pot elevators. This prevents the water that was just drained from making its way back up the root zone, keeping the bottom of the container dry. However, pot elevators don't come in all sizes, and they are an added cost and a nuisance in the garden.

Humidity is another element that has a direct impact on the rate of photosynthesis of a plant. Young plants need more humidity to photosynthesize (70% to 80% relative humidity (RH)), growing plants need a medium level of humidity (60% to 70% RH), and flowering or fruiting plants need lower humidity (50% to 60% RH). If these humidity levels are higher or lower than the desired ranges, plants will suffer, and their growth will be stunted or even stopped. In order to maintain a high-humidity (70% to 80%) environment for young plants, gardeners often place their plants in an enclosed transparent plastic dome with small openings, allowing the humidity to stay inside the compartment. Alternatively, gardeners place individual perforated transparent plastic cups on top of their plants until they are big enough, at which point they remove the cups and leave the plants out in the open. Plastic domes or cups, however effective, are a nuisance to clean. A more expensive solution involves using expensive electronic equipment that regulates humidity and temperature with devices such as an exhaust fan, air conditioner, humidifier, heater, and dehumidifier.

Hygiene in gardening equipment is important for achieving optimal crop yield and plant health. Using clean tools and equipment reduces the chances of bacterial, fungal, or viral infections. These contaminants can be detrimental to plant health, leading to disease, decreased nutrient uptake, and ultimately, compromised plant growth. Additionally, poor hygiene can attract pests that are hard to eradicate. Therefore, the use of hygienic and easy-to-clean gardening equipment is important to ensure a sanitary growing environment.

Poorly designed equipment that is difficult to clean can harbor harmful pathogens, fungi, and bacteria. This includes equipment with sharp corners that are hard to access with a cleaning brush or sponge, intricate features and details that are not reachable, or pockets that allow for water to sit in. Not only do these features make it more difficult to clean the equipment, but it also makes it easier for pathogens to settle in even after the equipment is clean. In order to be truly hygienic, a product needs to not only be easy to clean but also easy to stay clean.

On top of these problems, the environmental costs of single-use, plastic transplant cups, pots, and bags are high. The amount of plastic wasted every year due to transplanting plants in North America and globally is an important consideration.

Accordingly, there is a need for improved plant containers to address the above-noted limitations of existing plant containers.

### SUMMARY

Described herein are plant containers that may make it easier and faster for gardeners to remove or transplant their plants from. Described herein are plant containers that may provide better drainage and prevent waterlogging in the root zone. Described herein are plant containers that may promote the ideal humidity for their plants to thrive in. Described herein are plant containers that may make it easier and faster to clean than a regular pot or container. The removable bottom plate may make it faster and easier for gardeners to remove or transplant their plants by allowing them to raise the entire root ball up with the bottom plate by simply pushing it with their finger or hand, which consequently may minimize transplant shock to the roots. If the plant is ready to be disposed of, this makes it easier for the gardener to do so. The drainage cutouts and convex or conical shape of the removable bottom plate may advantageously provide better drainage for the roots, promoting better root development and preventing root rot. The raised bottom edge of the bottomless cup may ensure that the bottom plate stays off the ground. The side opening may allow runoff water to spill over, preventing it from going back up and water-logging the roots. Lastly, the removable transparent dome at the top may create the ideal humidity setting for plants and clones to thrive in by covering a volume above the cup that is about the same size as the cup itself.

According to an embodiment, there is a plant container comprising a hollow body and a removable bottom plate forming a raisable bottom of the plant container. The hollow body includes a top opening and a bottom opening and an internal ridge for retaining the bottom plate between the top opening and the bottom opening. At least one runoff exit is in a bottom edge of the hollow body. According to various embodiments, the hollow body may be cylindrical, frustoconical or polyhedral in shape.

The bottom plate may include a conical structure with a drainage angle. The bottom plate may include one or more drainage cutouts and may also include perforations passing between a top and a bottom of the bottom plate. The hollow body may include at least one vertical ridge configured to align with a drainage cutout to align the bottom plate to a final position.

According to some embodiments, the plant container includes a transparent dome for covering the top opening of the bottomless cup. The hollow body may include a lock feature on the top opening configured to engage a rim of the dome in an interference fit.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIGS. 1A and 1B are side and exploded views, respectively, of a plant container, in accordance with an embodiment;

FIG. 1C is a bottomless cup, in accordance with an embodiment;

FIG. 2A is a magnified view of region A in FIG. 1A showing a dome snap lock, according to an embodiment;

FIG. 2B is a magnified view of region B in FIG. 1A showing a base ridge, according to an embodiment;

FIGS. 3A and 3B are perspective and side views, respectively, of a bottom plate of the plant container of FIGS. 1A and 1B;

FIG. 3C is a side view of a bottom plate according to another embodiment;

FIG. 4 is a perspective view of a bottomless cup according to an embodiment; and

FIG. 5 is an illustration of the plant container of FIG. 1A in use, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

As used herein, a value with (″) indicates a value in inches, for example 1″ means 1 inch. When a tilde (~) is used herein, it signifies a range of ±10% of the indicated value. For example, ~1.0 means between 0.9 to 1.1.

In the drawings, the parts of the plant container are illustrated as transparent to aid in showing various features of the plant container. It should be noted that the parts of the plant container, other than the transparent dome, are not required to be transparent.

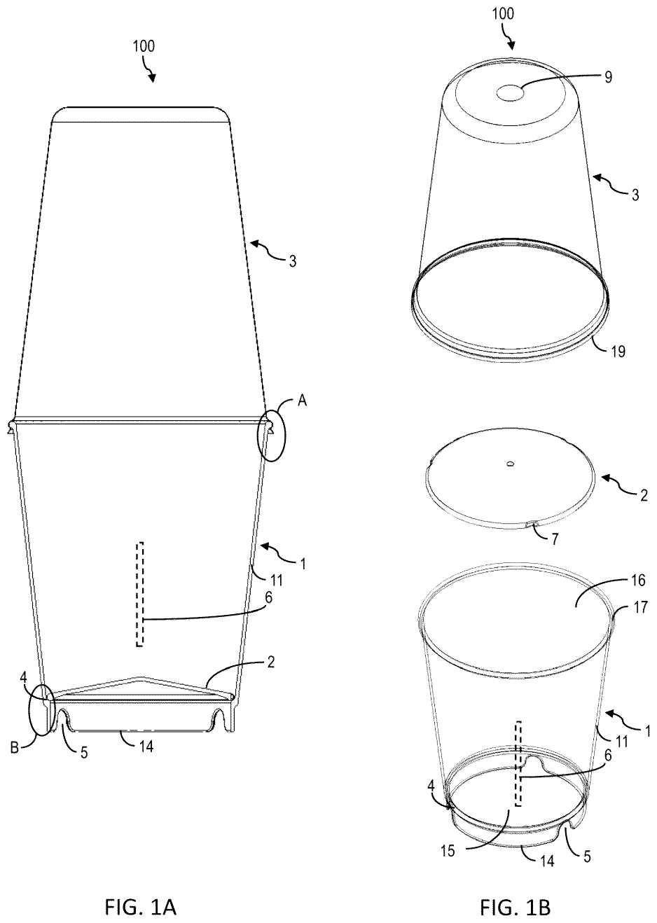

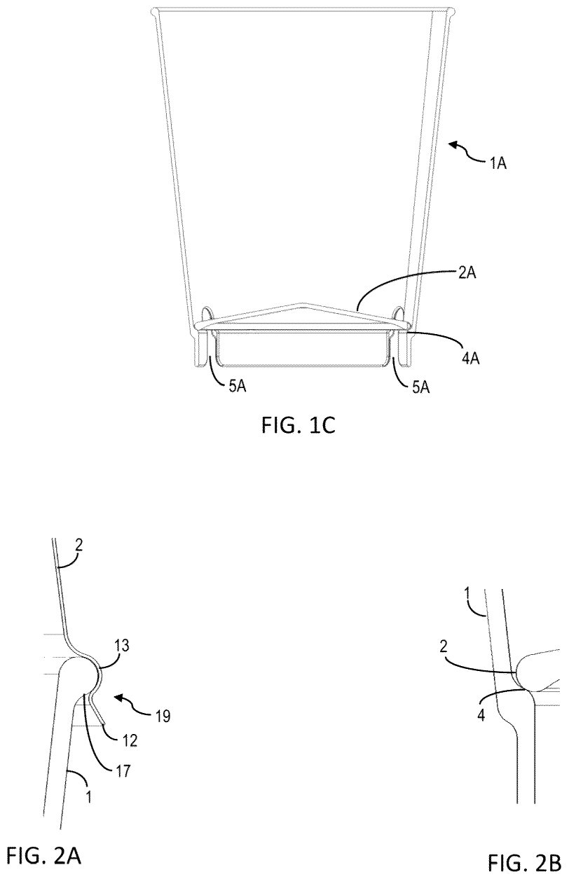

Referring to FIGS. 1A and 1B, illustrated therein is a plant container 100, in accordance with an embodiment. The plant container 100 includes a bottomless cup 1, a bottom plate 2 and a dome 3. According to other embodiments, the plant container 100 includes the bottomless cup 1 and the bottom plate 2, without the dome 3.

The bottomless cup 1 is a hollow body configured to hold growth media (e.g., soil, peat, coco-coir, rockwool, etc.) and the roots of a plant growing in the growth media. The bottomless cup 1 has an internal horizontal base ridge 4 around an inner circumference of the bottomless cup 1 for supporting the bottom plate 2. The internal base ridge 4 is disposed from a bottom edge 14 to support the bottom plate 2 above the bottom edge 14. The bottomless cup 1 has one or more side openings/runoff exits 5 in the bottom edge 14 for drainage to prevent waterlogging of the growth media and roots within the bottomless cup 1.

The bottomless cup 1 is preferably shaped as a hollow inverted frustrum of a cone having a top opening 16 with a smaller diameter than a bottom opening 15. According to another embodiment, the bottomless cup 1 is shaped as a hollow, cylinder with both the top opening 16 and the bottom opening 15 having the same diameter. According to other embodiments, the bottomless cup 1 is shaped as a hollow polyhedron with three or more sides with the top opening and the bottom opening having the same or different shapes and dimensions.

According to various embodiments, the wall (or walls) 11 of the bottomless cup 1 may have various thicknesses. According to some embodiments, the wall(s) 11 of the bottomless cup 1 may also be perforated or have cutouts 6 above the base ridge 4 to allow for better drainage. The wall(s) 11 may have a thicknesses gradient across the bottomless cup 1, such as a pattern of waves. The bottomless cup 1 may be flexible/pliable or substantially rigid.

The bottomless cup 1 directs the water added through the top opening 16 to feed the plant toward the bottom opening 15 for drainage by gravity. The bottomless cup 1 limits the growth of the roots of said plant to the dimensions of the bottomless cup 1. The bottomless cup 1 may thus stimulate plants to produce more internal roots, and consequently promote more root growth once the plant has been transplanted into the next pot. The bottomless cup 1 may be constructed of plastic, metal, wood, silicone, composite material or any other suitable material that can hold a volume of growth media.

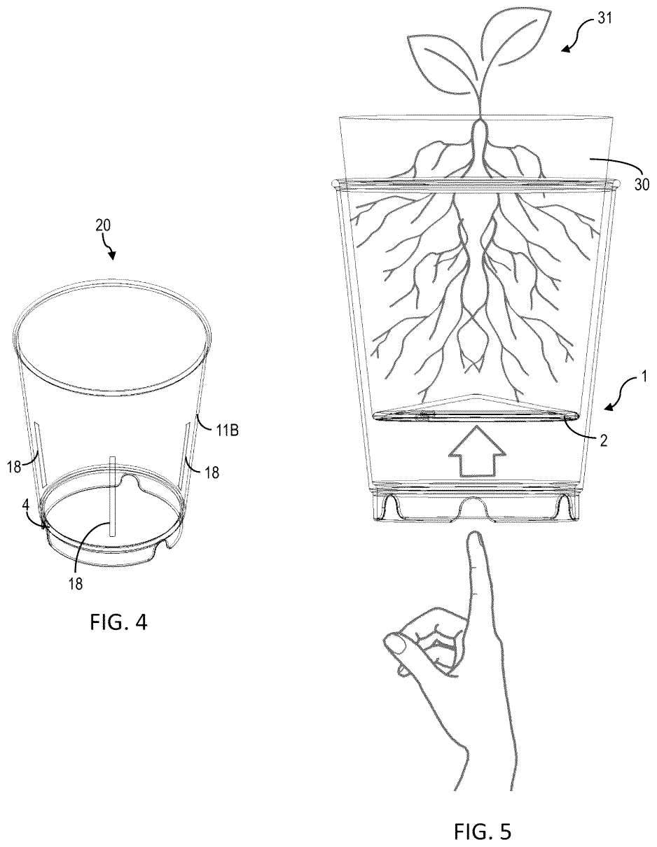

Referring to FIG. 4, shown therein is a bottomless cup 20 according to another embodiment. The bottomless cup 20 is substantially similar to the bottomless cup 1 in FIGS. 1A and 1B, and further includes one or more vertical ridges 18 protruding from the interior of the bottomless cup 20. The vertical ridges 18 may run anywhere from the top of the bottomless cup 20 to just above the base ridge 4. The vertical ridges 18 may be angularly spaced to align with the drainage cutouts 7 on the bottom plate 2 such that when the bottom plate 2 is placed inside the bottomless cup 20, the ridges 18 will catch on the drainage cutouts 7 and orient the bottom plate 2 to its final position. It should be noted that the number of ridges 18 may be fewer than the number of drainage cutouts 7.

In addition to orienting the bottom plate 2, the ridges 18 may add reinforcing strength to the bottomless cup 20 in the manner of structural ribs, such that the wall(s) 11B of the bottomless cup 20 can be made thinner.

Referring to FIGS. 1A and 2B the base ridge 4 retains the removable bottom plate 2 above the bottom edge 14 of the bottomless cup 1. The base ridge 4 may inhibit roots and growth media (e.g., soil, peat, coco-coir, rockwool, etc.) from escaping through the sides of the bottom plate 2.

According to various embodiments, the base ridge 4 and the bottomless cup 1 can be manufactured as a single part, or as an assembly of multiple parts. The base ridge 4 generally takes the form of a ledge running around the internal circumference of the bottomless cup 1. As shown in the drawings, the base ridge 4 is a ledge, having a diameter smaller than the diameter of the bottomless cup 1 immediately above it, and smaller than the diameter of the bottom plate 2 thus allowing the bottom plate 2 to sit on the base ridge 4, and be retained by the base ridge 4 instead of passing below the base ridge 4.

According to other embodiments, the base ridge 4 includes a cross section of the bottomless cup 1 that is smaller than the cross section of the bottomless cup 1 above it, but instead of taking the shape of a ledge, the base ridge may comprise an internal ring, pins, walls, indents, thinner cross sections, or any structures whose primary function is to hold the bottom plate 2 in place.

Referring again to FIGS. 1A, 1B, the bottom plate 2 is configured to be retained atop the base ridge 4 when the bottom plate 2 is placed into the bottomless cup 1 through the top opening 16. The bottom plate 2 forms a bottom of the plant container 100 and serves to hold the growth media and roots in place. The bottom plate 2 includes drainage cutouts 7 to provide drainage for excess water. According to various embodiments, the bottom plate 2 may be constructed of any rigid or flexible material such as plastics, metals, wood, silicone, composite material, or any other suitable material that holds its shape naturally, including biodegradable or consumable materials that can be transplanted with the root ball into its final container, e.g. compressed soil or peat pucks, fertilizer pucks, mycorrhizae and kelp pucks, or any other plant cultivation ingredient. The bottom plate 2 is generally shaped and sized to match the horizontal cross-section of the bottomless cup 1 just above the base ridge 2.

As shown in FIG. 5, the bottom plate 2 is vertically moveable (raisable) within the bottomless cup 1 to allow gardeners to remove or transplant a plant 31 by pushing the bottom plate 2 up with their finger(s) or any other actioning device, thus removing the entirety of the root ball 30 (including the growth media) from the bottomless cup 1 without stressing the roots. The bottom plate 2 is also removable from the bottomless cup 1 to allow more easily cleaning of the parts 1, 2 of the container 100. In addition, the bottom plate 2 may prevent pathogen build up by making it easier for gardeners to clean the container 100 since there are no sharp corners, edges or indentations on the bottom plate 2, the bottomless cup 1 or the dome 3.

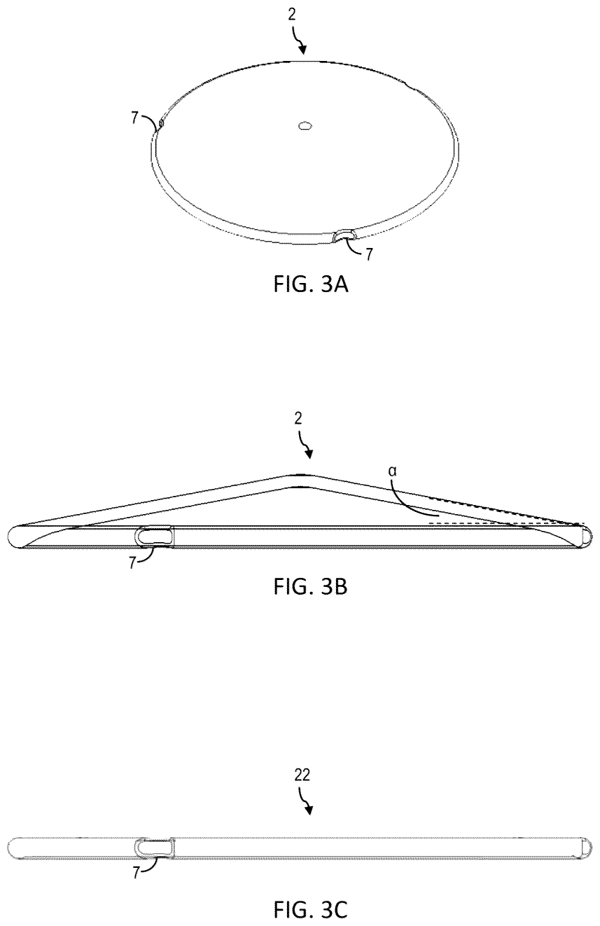

Referring to FIGS. 1A, 3A and 3B, according to a preferred embodiment, the bottom plate 2 includes a thin-walled, shallow (height smaller than width), wide-brimmed, convex/conical structure, with an outer diameter substantially the same shape and dimensions as the internal base ridge 4, such that the bottom plate 2 sites atop the base ridge 4, but is not small enough to go through the base ridge 4 when placed into the bottomless cup 1. The bottom plate 2 conical structure has a drainage angle, α, between, for example, 1 degree to 30 degrees, and drainage cutouts 7 (for example, no more than 3″ wide) around its edge.

According to another embodiment shown in FIG. 3C, the bottom plate 22 is flat rather than conical, with no drainage angle. According to other embodiments, wherein the bottomless cup 1 is polyhedral, the bottom plate, includes a flat or convex polygonal structure in the same shape as the cross section of the internal base ridge. According to some embodiments, the bottom plate 2, 22 may include perforations passing from a top to a bottom of the bottom plate 2, 22 instead of, or in addition to, the drainage cutouts 7 in the side edge of the bottom plate 2, 22.

Referring to FIGS. 1A and 1B, the bottomless cup 1 includes side openings/runoff exits 5. The runoff exits 5 serves to allow excess runoff water to disperse once it passes through the bottom plate 2, inhibiting it from building up under the bottomless cup 1 and going back up via water tension/capillary action, water-logging the roots, stunting growth and increasing chances of disease. The runoff exits 5 are located in the bottom edge 14 of the bottomless cup 1 and include cutouts, cut perpendicular to the wall(s) of the bottomless cup 1, extending from the bottom edge 14 of the cup to anywhere below or at the base ridge 4.

According to some embodiments, as shown in FIG. 1C, the bottomless cup 1A includes runoff exits cutouts 5A that extend through the base ridge 4A to above the bottom plate 2A. In these embodiments, the bottom plate 2A does not need (but may still have) side cutouts or openings for water drainage since the water can drain directly through the extended runoff exit cutouts 5A.

Referring again to FIGS. 1A and 1B, according to some embodiments, the transparent humidity dome 3 is dome shaped with substantially the same overall dimensions and volume as the bottomless cup 1. The dome 3 is transparent to allow light (including visible light and other wavelengths that are “visible” to plants but invisible to humans) to pass through. According to some embodiments, the dome 3 has one or more vent holes 9 for air circulation. According to some embodiments, the vent hole 9 may be opened and closed by a movable cover to regulate humidity and temperature. The dome 3 can be removably attached (i.e., friction/interference fit) over the top opening 16 of the bottomless cup 1. The dome 3 serves to maintain the humidity around the plant (e.g., around 70% to 90% RH), which may be ideal for young plants to thrive in.

The dome 3, includes a rim 19 having a snap-lock mechanism (FIG. 2A) that engages a locking feature 17 of the bottomless cup 1 to attach the bottomless cup 1 and the dome 3 to form an enclosure. This enclosure provides a high-humidity environment for plants to thrive in and can be controlled by leaving the vent hole(s) 9 open or closed. The dome 3 can be constructed of transparent plastic, glass, or any material that is transparent to light.

Generally, the shape and dimensions of the rim 19 are substantially similar to the shape and dimensions of the top opening 16 of the bottomless cup 1. For example, if the bottomless cup 1 is cylindrical or frustoconical in shape, the top opening 16 and the rim 19 are circular; if the bottomless cup 1 is shaped as a hollow four-sided polyhedron, the top opening 16 and the rim 19 are shaped as a 4-sided polygon.

Referring to FIG. 2A, the bottomless cup 1 includes a locking feature 17 for engaging the rim 19 of the dome 3. The cup lock feature 17 serves to allow the dome 3, to snap into place and stay attached covering the bottomless cup 1, and also reinforces the structural integrity of the bottomless cup 1. The cup lock feature 17 includes a thicker section of the cup wall, located at the very top edge of the bottomless cup 1, in the shape of a hoop with a diameter larger than the thickness of the wall.

According to other embodiments, the lock feature 17, may take the shape of a ring, pins, walls, ridges, indents, locking lugs, screw threads, thinner cross sections, or any structure whose function is to engage the rim 19 of the dome 3 in a friction/interference fit to removably attach the dome 3 over the bottomless cup 1 to form an enclosure. In an embodiment, the lock feature 17 is not present.

The rim 19 of the dome 3 is configured attached the dome 3 over the top opening 16 of the bottomless cup 1 and hold it in place. The rim 19 includes a circular groove 13 adjacent the bottom edge 12 of the dome 3 which widens to the same outer diameter of the cup snap lock feature 17. Below the groove 13, the rim 19 flares outward to the edge 12, in order to make it easier to place the dome 3 on top of the bottomless cup 1. The material of the rim 19 is suitably semi-rigid and elastic, in order for the rim 19 of the dome 3 to widen and fit over to top opening 16 of the bottomless cup 1 and the snap lock feature 17 is seated in the groove 13.

According to other embodiments, the snap lock mechanism for attaching the dome 3 to the bottomless cup 1 can be achieved through a number of different mechanisms, such as snap locks, magnets, threads, pins, walls, or anything that serves the purpose of removably attaching the dome 3 to the bottomless cup 1 in a way that prevents them from coming apart easily.

While the above description provides examples of one or more apparatus, methods, or systems, it will be appreciated that other apparatus, methods, or systems may be within the scope of the claims as interpreted by one of skill in the art.

1. A plant container comprising:
a hollow body comprising:
a top opening and a bottom opening;
an internal ridge between the top opening and the bottom opening;
at least one runoff exit in a bottom edge of the hollow body; and
a removable bottom plate configured to be retained atop the internal ridge,
wherein the bottom plate forms a raisable bottom of the plant container.

2. The plant container of claim 1, wherein the hollow body is cylindrical, frustoconical or polyhedral in shape.

3. The plant container of claim 1, wherein the hollow body includes one or more cutouts above the internal base ridge.

4. The plant container of claim 1, wherein the internal ridge is adjacent to the bottom opening.

5. The plant container of claim 1, wherein the internal ridge is a ledge running around an internal circumference of the hollow body.

6. The plant container of claim 1, wherein the bottom plate includes one or more drainage cutouts in a side of the bottom plate.

7. The plant container of claim 1, wherein the bottom plate includes one or more perforations passing between a top and a bottom of the bottom plate.

8. The plant container of claim 1, wherein the bottom plate includes a conical structure with a drainage angle.

9. The plant container of claim 1, wherein the bottom plate is constructed of biodegradable material.

10. The plant container of claim 6, wherein the hollow body further comprises at least one vertical ridge configured to align with a drainage cutout to align the bottom plate to a final position.

11. The plant container of claim 1, wherein the runoff exit extends from the bottom edge up to or below the internal ridge.

12. The plant container of claim 1, wherein the runoff exit extends from the bottom edge through the internal ridge to above the bottom plate.

13. The plant container of claim 1, further comprising a transparent dome for covering the top opening of the bottomless cup.

14. The plant container of claim 13, wherein the dome includes at least one vent hole.

15. The plant container of claim 12, wherein the done includes a moveable cover for opening and closing the vent hole.

16. The plant container of claim 13, wherein the hollow body includes a lock feature on the top opening configured to engage a rim of the dome in an interference fit.

17. The plant container of claim 16, wherein the rim of the dome includes a groove for engaging the lock feature in an interference fit.

18. The plant container of claim 16, wherein the rim of the dome includes a flared edge.
